(19) United States
(12) Patent Application Publication
(10) Pub. No.: US 2008/0068144 A1
(43) Pub. Date: Mar. 20, 2008

(54) Control system

(75) Inventor: Jiro Sato, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/898,785

(22) Filed: Sep. 14, 2007

(30) Foreign Application Priority Data
Sep. 19, 2006 (JP) 2006-252129

(51) Int. Cl. B60R 25/10

(52) U.S. Cl. 340/426.24; 340/426.36

(57) ABSTRACT

A service application is installed as a software program to intervene between a sever application and a client application in each electronic control unit. Each service application is to transfer required information while executing format conversions, arbitrations, etc.

### CROSS REFERENCE TO RELATED APPLICATION

This application is based on and incorporates herein by reference Japanese Patent Application No. 2006-252129 filed on Sep. 19, 2006.

### FIELD OF THE INVENTION

The present invention relates to a control system in which multiple in-vehicle electronic control units are connected with each other through a network.

### BACKGROUND OF THE INVENTION

In a vehicle, various kinds of devices are controlled by electronic control units. Those multiple electronic control units are connected via a network to cooperate with each other. Furthermore, the electronic control units may be connected also with a system outside the vehicle via a wireless communication. For instance, the outside system is a server which provides traffic information, amusement information, or mail services, and a home-use system.

In such environment, platforms which operate applications in the individual electronic control units are preferably identical to each other. This may secure the reusability of the applications in building new systems and the compatibility between the applications.

In a vehicle, multiple electronic control units coexist to individually include different types of applications. For instance, an application is for an engine control to collect data periodically and output the result continuously with advanced reliability; an application is for a vehicle body system to execute a series of sequences on the basis of operation of the user; and an application is for navigation to use large-scale data but not require very high reliability.

Thus, a control content or an available resource greatly varies in each of the multiple electronic control units connected via the network in the vehicle. This makes it difficult to use the same platform in the multiple electronic control units.

Here, the reusability and compatibility in applications are subjects different from each other. Microcomputers included in the electronic control units develop in speeds, integrations, or functions every year. In software program development languages, a language with the higher abstraction degree to provide high development efficiency, like the model language, comes out.

In such a state, the increase in the reusability of the application on the same platform is not necessarily a means for providing effective development. In contrast, the portability of the application can be increased by code generation according to platforms, using the model language etc. Thus, rather, the increase in the portability may improve efficiency of development.

Moreover, the compatibility of applications is enough if expected sequence certainly takes place in communication between the applications. Thus, the platforms need not be identical in the multiple electronic control units.

Functions potentially develop and new applications may be added in electronic control units. More important subject from now on is to suppress influence on existing applications to the minimum.

Whenever an application is added for realizing a new function, extensive correction or improvement in the existing application may be needed. In this case, the great effort will be needed for the development.

### SUMMARY OF THE INVENTION

The present invention is made in consideration of such an issue. It is an object of the present invention to provide a control system which allows an addition of an application for realizing a new function while suppressing influence on existing applications to the minimum.

To achieve the above object, according to an example of the present invention, a control system is provided as follows. The control system includes a plurality of electronic control units communicated with each other via a network. A first application is provided in a first electronic control unit of the plurality of electronic control units. A second application is provided in a second electronic control unit being any one of the plurality of electronic control units. The second application is capable of executing a predetermined function. A first format of demand information is necessary for the first application to issue an execution demand to cause the second application to execute the predetermined function. The first format of the demand information is predetermined. A service interface is provided in each of the plurality of electronic control units as a software program and configured to receive from the first application the demand information and give to the second application the received demand information in a second format, which indicates a function instruction for executing the predetermined function.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing a configuration of a control system in a vehicle according to an embodiment of the present invention;

FIG. 2 is a diagram for explaining services and operations in in-vehicle devices;

FIG. 3 is a diagram for explaining an example of specifying service usage for generating a service interface;

FIG. 4 is a diagram for explaining roles and operations of components of a service interface;

FIG. 5A is a diagram for explaining a comparative example when a new application is added in a control system; and

FIG. 5B is a diagram for explained an example when a new application is added in the control system according to the embodiment.

### DETAILED DESCRIPTION OF THE PREFERRED EMBODIMENTS

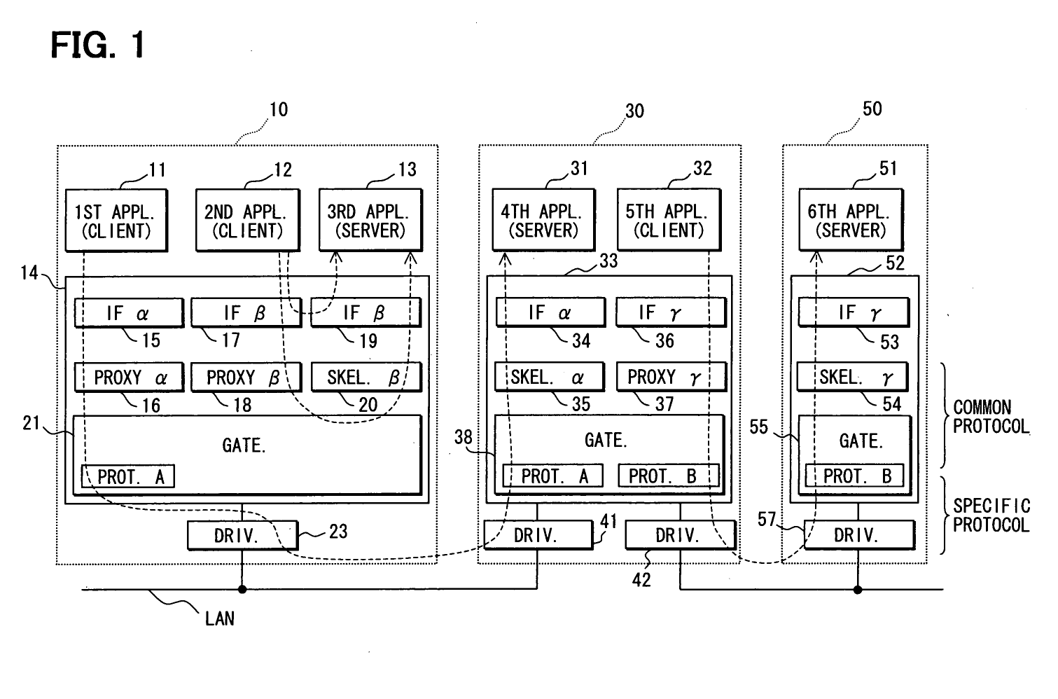

An embodiment of the present invention is directed to a control system in a vehicle. A block diagram showing a configuration of the control system is shown in FIG. 1. Here, although including only electronic control units 10, 30, 50, the control system may include more electronic control units. Moreover, for instance, the control system may be connected with an external system (a server for providing traffic information, amusement information, mail services, etc., and a home-use system) via wireless communication.

In FIG. 1, the electronic control units 10, 30, 50 have individual functions to control operations of various kinds of in-vehicle devices, such as controlling lock and unlock of each door of the vehicle, controlling opening and closing of each window, and controlling ON and OFF of each light.

Each of the electronic control units 10, 30, 50 is a usual computer having a known CPU, ROM, RAM, I/O, and bus line connecting the preceding components. Each electronic control unit 10, 30, 50 executes various kinds of applications including control of operations of the in-vehicle devices. Thus, the programs corresponding to the applications are written in the ROM, the CPU or the like executes data processing according to those programs.

In this embodiment, a service interface 14, 33, 52 is installed in each electronic control unit 10, 30, 50 as a software program. Each service interface 14, 33, 52 receives an execution demand of a desired function of a server application, which controls operations of each of various kinds of in-vehicle devices, from a client application. The service interface 14, 33, 52 then provides an execution demand to the corresponding server application.

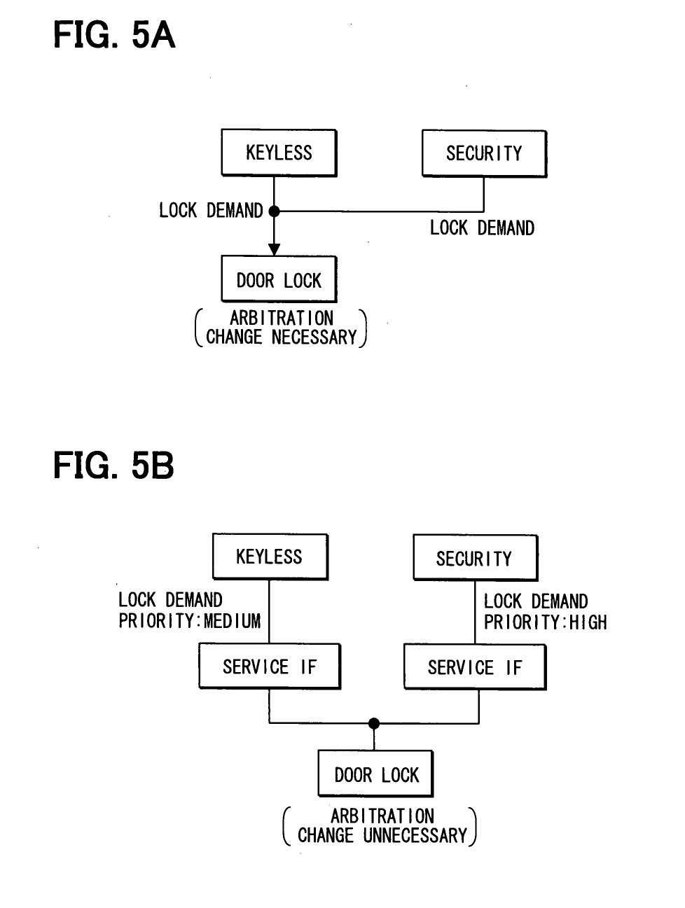

For example, in an in-vehicle control system, an application is already installed to control lock or unlock of a door when receiving a demand from an application about keyless entry which demands the lock or unlock according to operation of a portable key carried by the user of the vehicle. In this control system, as indicated in FIG. 5A, an application is added for newly realizing a security function. When this added application is for executing the door lock or automatic opening/closing of windows as part of the security function, the door lock demand is given to the application which controls the door lock.

Then, the demand from the application about keyless entry and the demand from the application about security may compete with each other. In the existing control system, the application which controls the door lock may take into consideration only the demand from the application about keyless entry. Thus, demands from multiple applications compete when the application for realizing the security function is added. This requires the correction about the arbitration process.

Functions required to vehicles are generally developing. The required functions may be able to be attained by adding a newly prepared in-vehicle device or combining operations of the existing in-vehicle devices. In any case, when a new application needs to be added, it is preferable that the influence of the correction to the existing application can be suppressed to the minimum. If it can be suppressed, the control system to meet the demand for highly developing functions can be efficiently provided.

In this embodiment, as mentioned above, the service interfaces 14, 33, 52 are installed in the electronic control units 10, 30, and 50, respectively. When demanding an execution of a desired function in a different application, each application is only required to provide the service interface 14, 33, 52 with demand information (i.e., demand massage) in a predetermined format. Then the service interface 14, 33, 52 provides the different application with demand information (i.e., demand message) in a function instruction format for executing the desired function.

The demand information from the service interface 14, 33, 52 includes priority (i.e., a priority level) for determining which execution demand is given priority when execution demands from multiple applications compete. This allows easier arbitration between the competing execution demands.

That is, according to this embodiment, the service interfaces intervene between applications to exchange required information while converting formats and executing arbitration, etc., as conceptually indicated in FIG. 5B. Thus, each service interface 14, 33, 52 serves as a substitute of an application (e.g., door lock application) who executes the desired function. This can relieve the application (e.g., keyless or security application) outputting the demand information from considering processes after passing through the service interface 14, 33, 52.

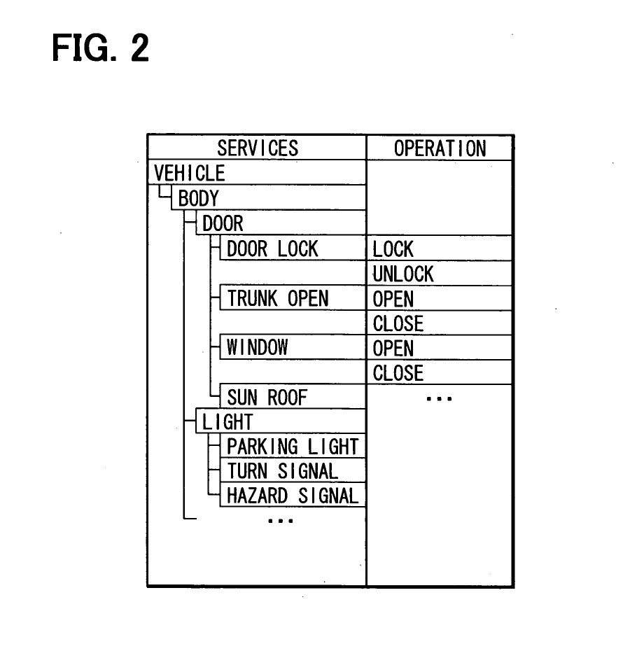

Hereafter, the service interface in this embodiment is explained in detail. Referring to FIG. 2, functions of in-vehicle devices are defined as serves. Furthermore, usages of the services are defined under the scope commonly covering the whole control system. Based on the defined usages, a first application can use a service by a second application.

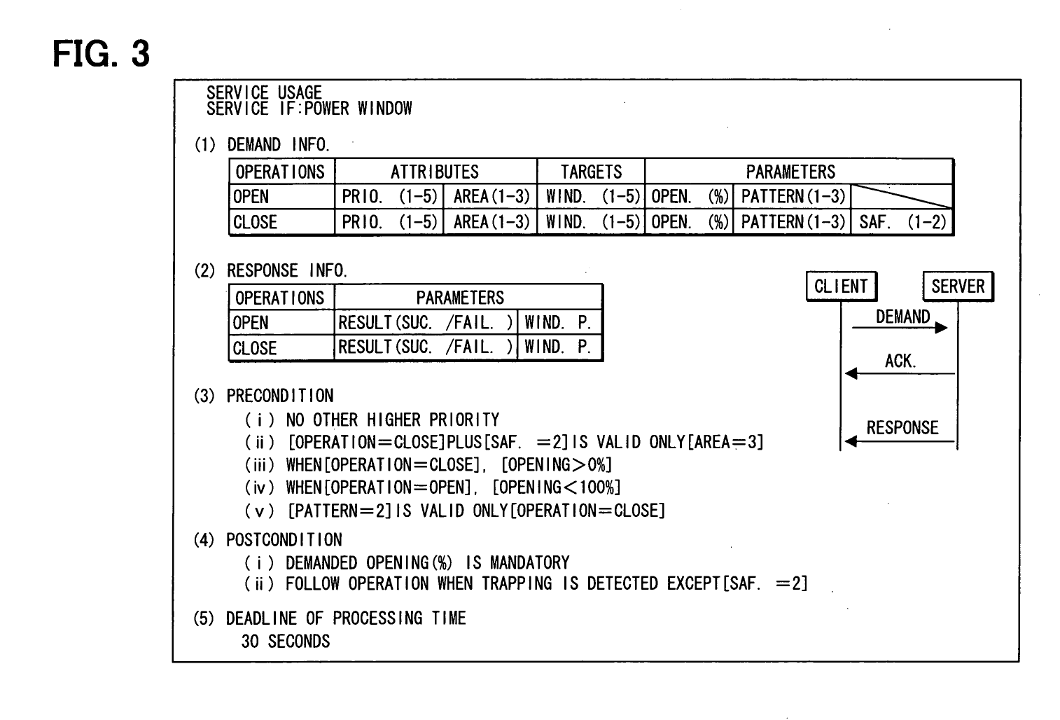

Referring to FIG. 3, the usage of the service includes the following: (1) a format of demand information necessary for an application as a client to demand an execution of a desired function (i.e., service); (2) a format of response information from an application as a server in response to the demand information; (3) a precondition for determining whether the server should execute the service according to the demand information; (4) a postcondition indicating a result from the execution of the service; and (5) a deadline of processing time indicating a maximum time for the server to execute the service. Here, an application which outputs an execution demand is called a client (or a client application), while an application which executes the service in response to the execution demand is called a server (or a server application).

FIG. 3 illustrates an example in which a target of the service is a power window (i.e., automatic window), and an operation of the service is opening/closing of windows. The example explains a format of demand information, a format of response information, a precondition (i.e., condition prior to process), a postcondition (i.e., condition posterior to process), and a deadline of processing time.

In addition, after the client issues (or outputs) an execution demand, the server returns a demand acknowledgment response and then returns the response information indicating the completion of the process. Here, the server may give to the client the deadline of processing time within the demand acknowledgment response. In this case, priority is given to the deadline of the processing time received in the demand acknowledgment response rather than the deadline specified in the service usage in FIG. 3.

The format of the demand information from the client contains kinds of operations, demanding agency attributes, instruction targets, and operation parameters. The demanding agency attribute includes a priority indicative of one of five priority levels; therefore, the arbitration process can be easily executed for the execution demands for the service from multiple clients competing.

An area is also included in the demanding agency attribute to be indicative of one of three levels. For instance, a first level indicates “outside of system,” which is specified when a remote control performs switching operation of the automatic window from the outside of the vehicle. A second level of “inside of system” is specified when the opening and closing switch disposed in the passenger compartment is operated. Furthermore, a third level of “safety secured area in system” is specified when the automatic window needs to be immediately operated from problems of security. Here, “safety secured area in system” has the highest priority.

The operation parameters contain an instructed opening, an operation pattern, and a safety level. The operation pattern includes multiple predetermined patterns, e.g., a first pattern of normal operation, a second pattern of shutting once and then opening, and a third pattern of operating after reporting subsequent operations using voice, buzzer, or blink of a light. The client specifies one of the operation patterns and outputs an execution demand. The safety level includes two levels, e.g., a first level in which a function of prevention for trapping objects is enabled, and a second level in which the function is disabled.

When receiving the demand information from the client, the server returns response information (i.e., response message) according to the format specified for the response information when the process is completed. The response information includes an operation kind and a response parameter. The response parameter includes a result based on the demand and a window position at the time of the completion of the process. The result is used for notifying the client of a success or failure in the execution according to the demand. In addition, in the failure notification, the cause of the failure is also notified to the client.

The server determines whether to operate or not according to the execution demand from the client, based on the precondition. The server then creates the response information including the determination result, and transmits it towards the client through the service interface.

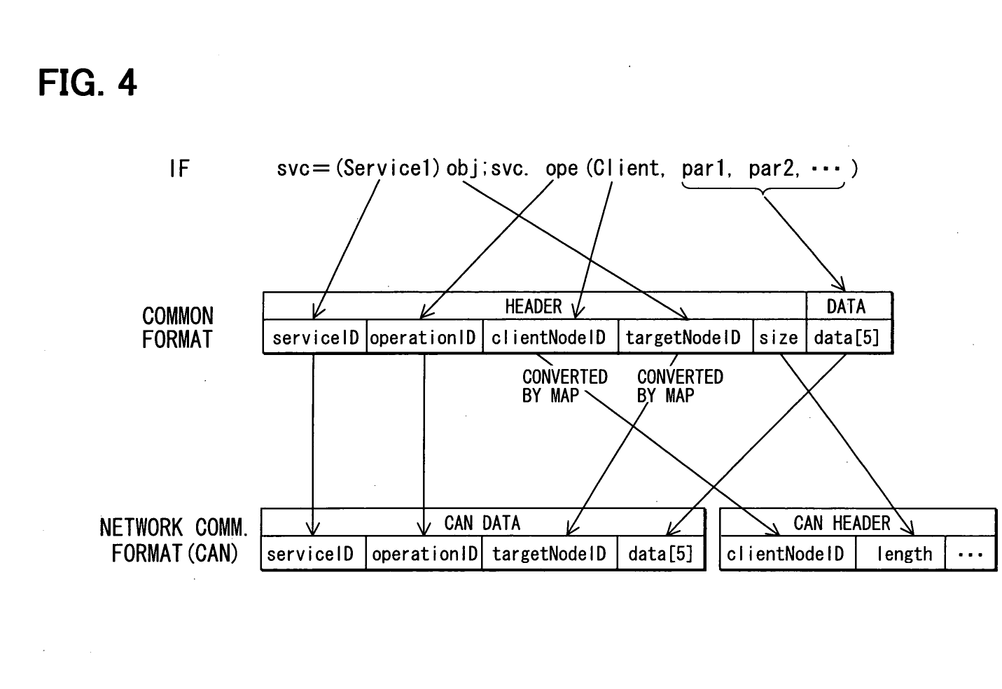

Roles and operations of components of the service interface are explained with reference to FIGS. 1, 4. Those take place when the demand information or response information are exchanged between applications as a server and a client.

The service interfaces 14, 33, 52 include interfaces 15, 17, 19, 34, 36, 53, proxies 16, 18, 37, skeletons 20, 35, 54, and message gateways 21, 38, 55.

For example, the interface α 15 is formed in the electronic control unit 10 corresponding to Service 1 by the fourth application 31 that is the server. When the execution demand for Service 1 by the fourth application 31 as the server arises (or is issued) from the first application 11 as a client, the interface α 15 is called by the first application 11 and receives the demand information for executing Service 1. Specifically, the interface such as the interface α 15 is expressed by a function formula, as indicated in FIG. 4. The first application 11 calls the function formula, inputs information necessary for the function formula, and gives it to the interface α 15.

The interface α 15 is united with the proxy α 16, and the demand information received by the interface α 15 is given to the proxy α 16. This proxy α 16 changes or converts the demand information into common communication information compliant with a communication format for common communications protocols used in communication between applications in the control system.

As indicated in FIG. 4, the common communication information having the common communication format is created based on the function formula in the interface α 15. The common communication format includes the following: “serviceID” indicating a kind of services, “operationID” indicating a kind of operations, “clientNodeID” indicating a client, “targetNodeID” indicating a server which executes the service, “size” indicating a data size of the communication information, and “data” indicating content of the demand information.

Moreover, the message gateway 21 communicates the common communication information towards the skeleton α 35 with which the proxy α 16 should communicate. As indicated in FIG. 1, the proxy α 16 is mounted in the electronic control unit 10, and the corresponding skeleton α 35 with which the proxy α 16 should communicate is mounted in the electronic control unit 30. Here, the common communication information changed by the proxy α 16 needs to be communicated through the in-vehicle LAN (Local Area Network) connecting the electronic control units 10 and 30 therebetween.

For this reason, the message gateway 21 is equipped also with a function to change the common communication information into the network communication information according to the network communication format for the communications protocols (protocol A) of the in-vehicle LAN. For example, the communications protocol A of the in-vehicle LAN may use CAN (Controller Area Network) specified in the ISO standard. FIG. 4 also indicates the conversion of the format of the communication information by the message gateway 21.

The network communication information changed by the message gateway 21 is transmitted to the in-vehicle LAN through a driver 23. This network communication information is received by the electronic control unit 30 based on targetNodeID included in the relevant communication information. That is, the communication information is taken in through a driver 41 and given to the message gateway 38.

In this case, the message gateway 38 executes a conversion process which format-converts the network communication information into the common communication information contrary to the conversion process mentioned above in the message gateway 21. The resultant common communication information is given to the skeleton α 35 based on serviceID or targetNodeID. The skeleton a 35 executes the process exactly contrary to that of the proxy α 16 mentioned above. That is, the common communication information according to the common communication format is changed into the function formula in the interface α 34, and given it to the interface α 34. Then, the fourth application 31 reads the function formula to thereby obtain information when demanded, i.e., the demand information outputted from the application 11.

In addition, the function formula of the interface α 34 may be the same as or different from that of the interface α 15. This depends on the execution instruction format of the service for the fourth application 31 of the server. That is, if the fourth application 31 has the same format as the first application 11 with respect to the kinds of operations, instruction targets, operation parameters, etc., the function formula of the interface α 34 accords with that of the interface α 15. However, when the fourth application 31 has an independent format, the function formula of the interface α 34 should follow the independent format. In any case, the interface has a role to change the demand information from the client application into the instruction information corresponding to the server application.

Moreover, when the fourth application 31 completes the process and returns the response information, the skeleton α 35 plays a role of a proxy to execute a process contrary to that during the communication of the demand information mentioned above; for example, the message gateway 38 changes the common communication information into the network communication information.

In the above example, the client application 11 which demands an execution of a service and the server application 31 which actually executes the service are mounted in the different electronic control units 10 and 30. However, the client application and server application may be mounted in the same electronic control unit. For example, in FIG. 1, the second application 12 of the client and the third application 13 of the server are mounted in the single electronic control unit 10.

In this case, the message gateway 21 receives the common communication information from the proxy β 18 and then transmits it as it is towards the skeleton β 20 with which the proxy β 18 should communicate. The message gateway 21 associates services (i.e., serviceID indicating the kinds of services) with targetNodeID indicating a server application to execute each service, and stores information about the electronic control unit including the server application. The communication destination can be assigned based on the stored information.

In addition, the second application 12 may have information to specify the third application 13 of the server to which the demand information for demanding execution should be transmit. Further, the interface β 19 accompanying the third application 13 may be called. In this case, the demand information can be directly transmitted to the third application 13 only through the interface β 19. If the function formula of Interface β can be called, the demand information can be directly given to the third application 13 using the function formula.

Moreover, as indicated in FIG. 1, this embodiment can apply to an in-vehicle LAN system including several networks having individually different protocols (Protocol A and Protocol B). In FIG. 1, the electronic control units 10, are connected by an in-vehicle LAN having Protocol A, while the electronic control units 30, 50 are connected by an in-vehicle LAN having Protocol B.

As mentioned above, in this embodiment, a service application is installed to intervene between the sever application and client application in the electronic control unit(s). The service application is to transfer necessary information while executing format conversions, arbitrations, etc. Therefore, influence on each existing application can be suppressed to the minimum. An application for realizing a new function can be easily added and reusability of the existing application can be improved, thereby providing an advantage.

Although the embodiment mentioned above is a desirable embodiment of the present invention, the present invention can be modified within an area not deviating from the scope thereof without being restricted. For example, in the embodiment mentioned above, although the interface is provided between the skeleton and server application, the skeleton may include the functional capability of the interface.

Moreover, in the embodiment mentioned above, information about the communication destination used when the client application demands execution of a service to the server application may be stored in the electronic control unit including the client application. A retrieval application can be designed to give the communication destination information to the client application in response to a question therefrom. This can eliminate need for each client application to store the information about the communication destination in order to demand execution of the service.

Furthermore, in the embodiment mentioned above, the demanding agency attributes of the format of the demand information include the priority and area. The priority is used in the arbitration process to determine which execution demand should be given the priority (or selected from) among multiple execution demands competing.

Further, the area of the demanding agency attribute can also serve as the information for determining which execution demand should be given the priority among multiple execution demands competing. Therefore, based on the area of the demanding agency attribute, the arbitration process can be executed. In this case, the “priority” can be omitted from the format of the demand information.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

Aspects of the subject matter described herein are set out in the following clauses.

As a first aspect, a control system is provided as follows. The control system includes a plurality of electronic control units communicated with each other via a network. A first application is provided in a first electronic control unit of the plurality of electronic control units. A second application is provided in a second electronic control unit being any one of the plurality of electronic control units. The second application is capable of executing a predetermined function. A first format of demand information is necessary for the first application to issue an execution demand to cause the second application to execute the predetermined function. The first format of the demand information is predetermined. A service interface is provided in each of the plurality of electronic control units as a software program and configured to receive from the first application the demand information and give to the second application the received demand information in a second format, which indicates a function instruction for executing the predetermined function.

For example, when the second application is for realizing an existing function in the vehicle, the usage of the function is specified beforehand. A format of demand information is specified as information required when the function is used in accordance with the usage.

For instance, the first application, which is a new application to use the function by the second application, is added. In this case, a service interface is provided to receive the demand information from the first application and gives the received demand information in a function instruction format to the second application.

When demanding an execution of a desired function of the second application, the first application is only required to provide the service interface with the demand information in a predetermined format. Thus, the addition of an application for realizing a new function can be allowed while suppressing influence on the existing application to the minimum.

As a second aspect, the demand information may include priority information for determining which execution demand is given priority when execution demands, which cause the second application to execute the predetermined function, issued from multiple applications compete with each other. If the first application is an existing one, its function may already be used by another application. In such a case, the execution demands by multiple applications may compete with each other. To that end, priority information for indicating priority levels may be included in the demand information. This allows easier arbitration between the competing execution demands.

As a third aspect, when provided with the function instruction, the second application may returns to the first application via the service interface response information indicating a result of operation based on the function instruction. Thereby, the first application can confirm whether the second application has executed the function to meet the demand.

As a fourth aspect, the service interface may include an interface which changes the first format into the second format, when the first electronic control unit and the second electronic control unit are identical and the first and second applications are thereby in a single electronic control unit, the demand information from the first application is given to the second application via the interface.

As a fifth aspect, the service interface may include an interface which changes the first format into the second format, a proxy which changes the demand information in the first format into common communication information following a communication format for a common communications protocol used in communication between applications in the control system, a skeleton which changes the common communication information into the demand information in the first format, and a message gateway which communicates the common communication information to the skeleton with which the proxy needs to communicate. When the first electronic control unit and the second electronic control unit are identical one, namely, in a single electronic control unit, the demand information from the first application is given to the second application via the proxy, the message gateway, the skeleton, and the interface.

Thus, when the first and second applications are provided in a single electronic control unit, the demand information is changed into common communication information following a communication format for a common communications protocol used in communication between applications. The common communication information can be easily communicated by any application. However, when the first application has information to specify the second application to which the demand information should be transmitted, the demand information may be directly transmitted only through the interface to the second application, as explained in the fourth aspect.

As a sixth aspect, when the first electronic control unit and the second electronic control unit are different from each other and the first and second application are thereby in the different electronic control units, respectively, the message gateway in the first electronic control unit may change the common communication information into the network communication information compliant with the communication format for the network communication protocol used for the network communication. The message gateway in the second electronic control unit may change the network communication information into the common communication information and give it to the skeleton, which is specified as a communication destination.

When the first and second applications are provided in the first and second electronic control units, which are different electronic control units, a network is needed to communicably connect the two electronic control units. Usually, the communications protocol in the network protocols uses a protocol specified in the ISO standard such as CAN. Therefore, it is necessary to convert the common communication information changed by the proxy into the network communication information according to the communication format for the network communication protocol. The message gateway may specify the skeleton with which the proxy needs to communicate and have a function for converting mentioned above. In this case, the message gateway can automatically determine or switch whether the conversion is executed or not, according to whether the skeleton of the communication destination is mounted in the same electronic control unit or in the different electronic control unit. Under the above configuration, a part depending on the platform can be limited to a part for changing the common communication information into the network communication information according to the communication format for the network communication protocol.

As a seventh aspect, information about a communication destination used when the first application issues the execution demand for the predetermined function may be stored in the first electronic control unit. Further, a retrieval application may be provided to give the communication destination information to the first application in response to a demand therefrom. This can eliminate need for each application to store information about a communication destination in order to issue an execution demand for executing a function.

It will be obvious to those skilled in the art that various changes may be made in the above-described embodiments of the present invention. However, the scope of the present invention should be determined by the following claims.

What is claimed is:

1. A control system including a plurality of electronic control units communicated with each other via a network, comprising:
a first application provided in a first electronic control unit of the plurality of electronic control units;
a second application provided in a second electronic control unit being any one of the plurality of electronic control units, the second application capable of executing a predetermined function, wherein a first format of demand information is necessary for the first application to issue an execution demand to cause the second application to execute the predetermined function, the first format of the demand information being predetermined; and
a service interface provided in each of the plurality of electronic control units as a software program and configured to receive from the first application the demand information and give to the second application the received demand information in a second format, which indicates a function instruction for executing the predetermined function.

2. The control system of claim 1, wherein
the demand information includes priority information for determining which execution demand is given priority when execution demands, which cause the second application to execute the predetermined function, issued from multiple applications compete with each other.

3. The control system of claim 1, wherein
when provided with the function instruction, the second application returns to the first application via the service interface response information indicating a result of operation based on the function instruction.

4. The control system of claim 1, wherein:
the service interface includes an interface which changes the first format into the second format; and
when the first electronic control unit and the second electronic control unit are identical to each other and the first and second applications are thereby in a single electronic control unit, the demand information from the first application is given to the second application via the interface.

5. The control system of claim 1, wherein:
the service interface includes an interface which changes the first format into the second format, a proxy which changes the demand information in the first format into common communication information following a communication format for a common communications protocol used in communication between applications in the control system, a skeleton which changes the common communication information into the demand information in the first format, and a message gateway which communicates the common communication information to the skeleton with which the proxy needs to communicate; and
when the first electronic control unit and the second electronic control unit are identical and the first and second application are thereby in a single electronic control unit, the demand information from the first application is given to the second application via the proxy, the message gateway, the skeleton, and the interface.

6. The control system of claim 5, wherein
when the first electronic control unit and the second electronic control unit are different from each other and the first and second application are thereby in the different electronic control units, respectively,
the message gateway in the first electronic control unit changes the common communication information into the network communication information compliant with the communication format for the network communication protocol used for the network communication while the message gateway in the second electronic control unit changes the network communication information into the common communication information and gives it to the skeleton, which is specified as a communication destination.

7. The control system of claim 1, wherein
information about a communication destination used when the first application issues the execution demand for the predetermined function is stored in the first electronic control unit, and a retrieval application is provided to give the communication destination information to the first application in response to a demand therefrom.
